(19) United States
(12) Patent Application Publication
(10) Pub. No.: US 2009/0267399 A1
(43) Pub. Date: Oct. 29, 2009

(54) LINEAR RETRACTOR SEAT TIE DOWN

(76) Inventors: Jeffrey Alan King, Markleville, IN (US); Jeffrey David Huck, Fortville, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 12/409,802

(22) Filed: Mar. 24, 2009

Related U.S. Application Data
(60) Provisional application No. 61/046,176, filed on Apr. 18, 2008.

(51) Int. Cl. B60N 2/02

(52) U.S. Cl. 297/378.14

(57) ABSTRACT

An extendable strap or member extendable from one portion of a collapsed seat to hold the remaining portion of the seat thereatop. A spring mounted within the seat is operable to retract the strap or member into the seat when not in use.

This application claims the benefit of U.S. Provisional Application No. 61/046,176, filed Apr. 18, 2008, which is hereby incorporated by reference.

### BACKGROUND OF THE INVENTION

1. Field of the Invention

The present invention relates generally to the field of devices for locking seats in a collapsed condition.

2. Description of the Prior Art

Passenger seats in vehicles, including boats and land vehicles, include a seat portion upon which the passenger sits and a back rest against which the passenger rests. In many cases, the back rest is hingedly and pivotally connected to the seat portion so that the back rest may be folded downward against the seat portion when not in use. Thus, space is saved and ready access is provided to the area behind the seat. It is desirable to provide a lockdown device or means for securing the back rest against the seat portion when folded downward. Disclosed is such a means.

### SUMMARY OF THE INVENTION

A foldable seat comprises a bottom portion upon which a person may sit and a back rest against which the person may rest. The back rest is movably mounted to the bottom portion and has an upright position whereat the back rest extends upwardly from the bottom portion and a downward position folded atop the bottom portion. A connector is mounted to the seat. A lockdown element is movably mounted to the seat and extends from a retracted position to an extended position to releasably connect to the connector whereat the element holds the bottom portion and the back rest together in the downward position. A spring is connected to the element. The spring has a normal state urging the element to a retracted position but yieldable to allow the element to extend out to the connector.

It is an object of the present invention to provide a device for holding a foldable seat in a collapsed position

A further object of the present invention is to provide an inexpensive and easy to use device on a foldable seat for releasably holding the foldable portion in a storage position.

Related objects and advantageous of the present invention will be apparent from the following description.

### BRIEF DESCRIPTION OF THE DRAWINGS

FIG. 1 is a cross-sectional view of a holder housing a compression spring urging a seat strap hold down device in a retracted position.

FIG. 2 is the same view as FIG. 1 only showing the strap in an extended position.

FIG. 3 is a cross-sectional view showing a holder housing an extension spring for urging a seat strap hold down device in a retracted position.

FIG. 4 is the same view as FIG. 3 only showing the strap in an extended position.

FIG. 5 is a fragmentary side view of the holder and strap of FIG. 1 having a snap connector mounted to the distal end of the strap to engage a mating connector on the back rest.

FIG. 6 is the same view as FIG. 5 only showing a buckle mounted to the distal end of the strap.

FIG. 7 is the same view as FIG. 5 only showing a tongue mounted to the distal end of the strap.

FIG. 8 is the same view as FIG. 5 only showing a connector restraint coupling mounted to the distal end of the strap.

FIG. 9 is a perspective view of a seat in an erect position with the strap pulled outwardly therefrom.

FIG. 10 is the same view as FIG. 9 only showing the strap in a retracted position.

FIG. 11 is a perspective view of a seat in the collapsed position showing the strap holding the back rest atop and adjacent the seat bottom.

### DESCRIPTION OF THE PREFERRED EMBODIMENTS

For the purposes of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

Referring to FIG. 11 there is shown a seat portion 30 atop of which the seat back rest 34 is folded downwardly. Seat portion 30 and back rest 34 are pivotally and hingedly connected together via a conventional manner. The seat may be mounted within a vehicle including a boat. A strap 17 extends outwardly from a slot in the seat portion and upwardly and partially around the seat back rest and is removably connected thereto. The seat includes means for retracting the strap when the strap is not in use. Likewise, once the free end of the strap is attached to the back rest, the strap is urged to not extend further outward thereby holding the seat portion and back rest together. It is desirable that the retraction of the strap be automatic once the free end is unattached from the back rest. The linear retractor seat tie down disclosed herein holds the back of the seat downwardly against the seat portion when the seat is unoccupied but retracts the strap when not in use.

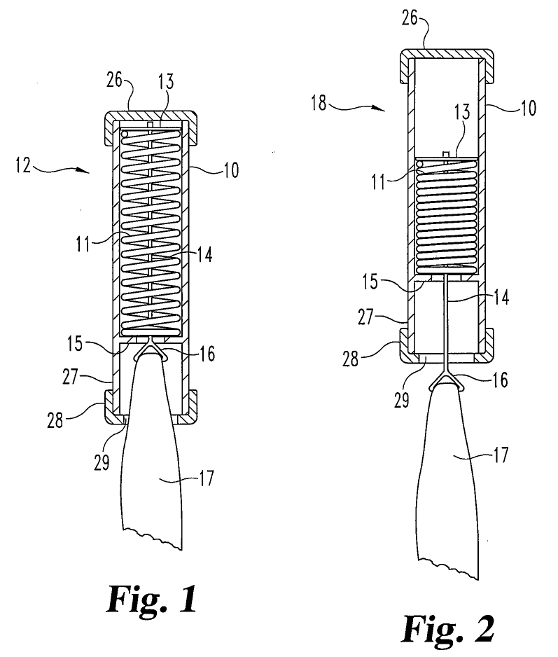

FIGS. 1-2 disclose use of a compression spring positioned within a tube or frame and operable to withdraw a web or strap to allow the strap to be retracted. In FIG. 1, the strap is in a retracted condition and the compression spring is in a normal expanded condition. In FIG. 2, the strap is extended with the compression spring being in the compressed state.

A tube 10 houses compression spring 11. A flat plate or other member 13 is positioned atop or at one end of spring 11. Member 13 is connected by a line or cable 14 to strap 17 fixedly attached to one end 16 of cable 14. An internal wall 15 fixedly secured to tube 10 has a central aperture through which cable 14 freely extends with the other end of the compression spring resting atop and against wall 15. Thus, in the normal retracted condition 12, spring 11 is in the expanded position whereas when strap 17 is pulled in an outward direction from tube 10, the strap forces plate 13 downwardly thereby compressing spring 11.

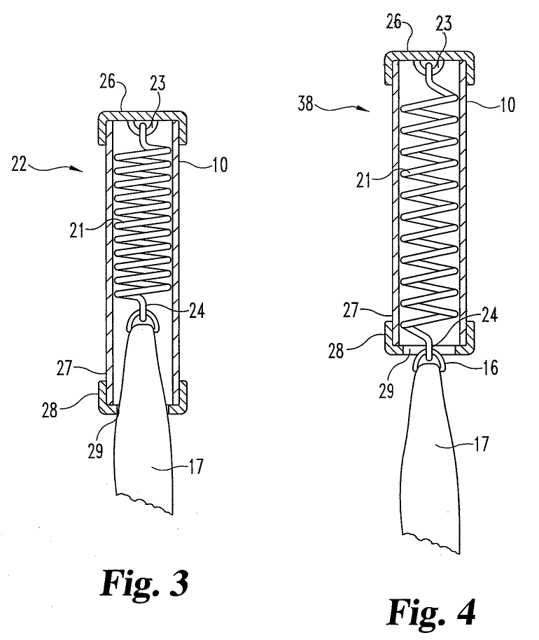

In FIGS. 3-4, an extension spring is used in lieu of the compression spring of FIGS. 1 and 2. An internal wall or member 23 is fixedly mounted to end 26 of tube 10. Extension spring 21 has one end fastened to member 23 whereas the opposite end 24 of extension spring 21 is attached to a ring or other mount connected to an end of strap 17. When strap 17 is pulled from the retracted condition 22 to the extended condition 38, the extension spring 21 expands from its normal collapsed condition to its extended position. The extension spring is operable to normally urge the strap into the tube.

End 26 of tube 10 is closed whereas end 27 of tube 10 has a cap 28 fixedly mounted thereto. Cap 28 has a slot 29 through which strap 17 extends. End 26 may be closed either by forming tube 10 so the end is closed or by closing end 26 by a cap.

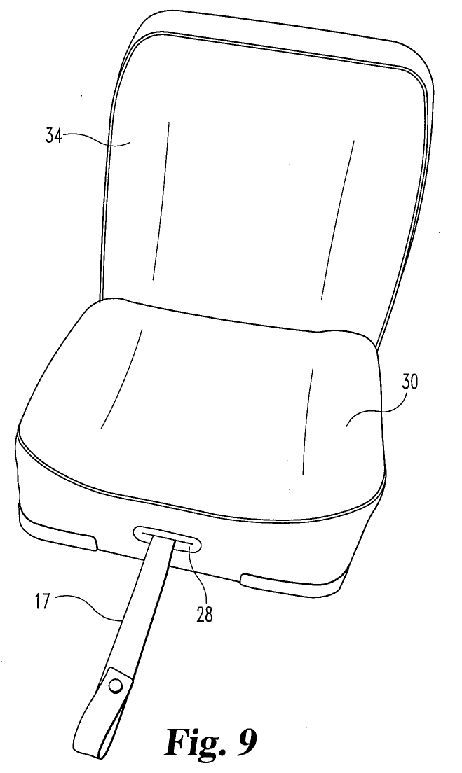

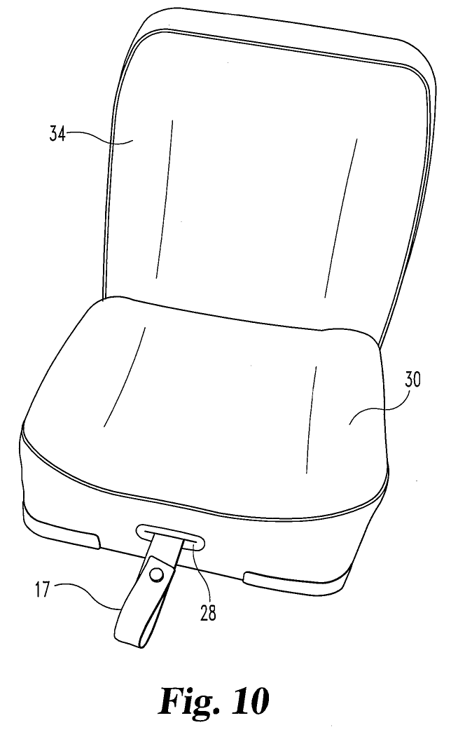

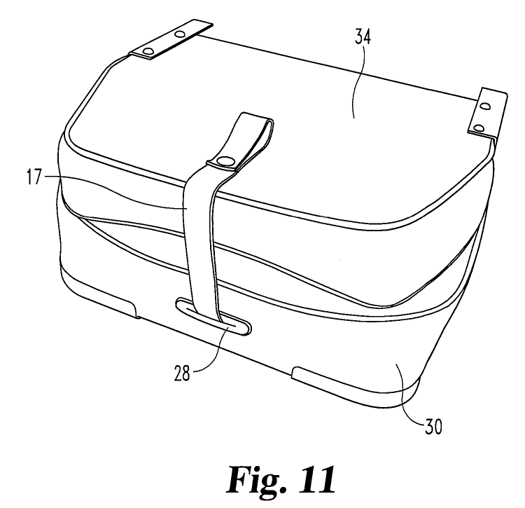

The tube 10 and spring along with the strap are mounted to the seat portion of the passenger seat. Referring to FIGS. 9 and 10, strap 17 extends outwardly therefrom. The strap extends outwardly from a cap or face plate 28 mounted to the seat portion 30 with the tube and spring being contained within the seat. The strap is in a retracted position in FIG. 10 whereas in FIG. 9 the strap is pulled outwardly to an extended position from the face plate and seat. Alternatively, the tube 10 and spring along with the strap may be mounted to the back rest 34.

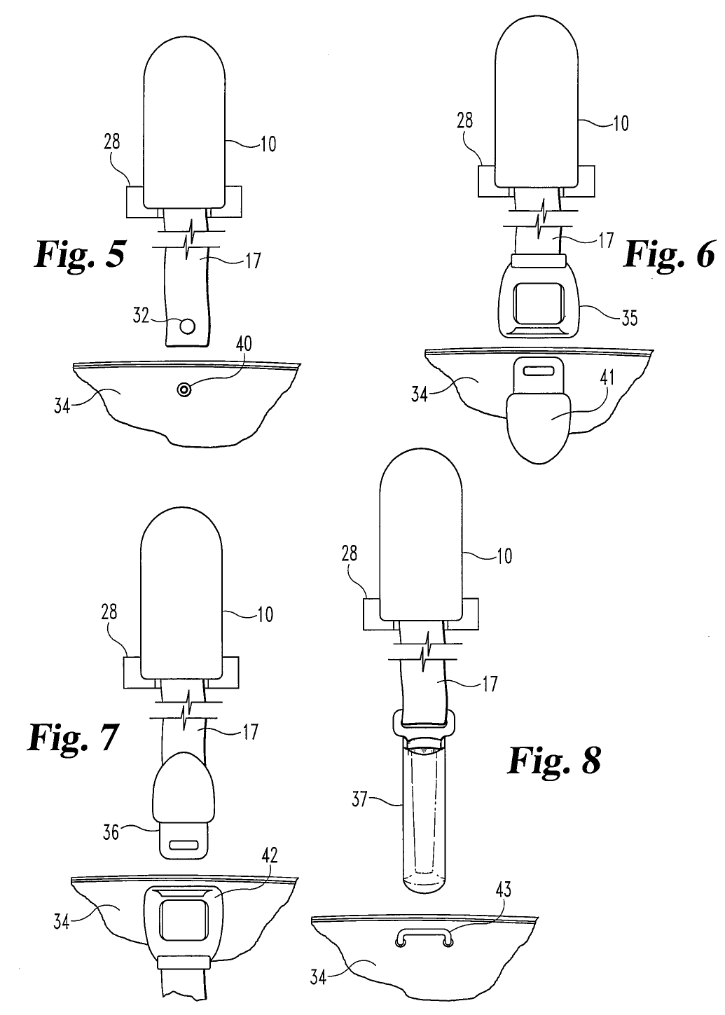

The outer or free end of the strap 17 includes a connector 32 (FIG. 5) to mate with and removably connect to a snap connector 40 (FIG. 5) mounted to the back side of the back rest. Seat rest 34 is pivotally mounted to seat portion 30 and is movable from a downward collapsed position (FIG. 11) to an erect position (FIG. 10). Many different connectors may be used to secure the distal end of the strap as shown in FIGS. 5-8. In FIG. 5, a female snap connector 32 is fixedly mounted to the distal end of the strap with a male snap connector 40 in turn mounted to the back rest 34 of the seat. The strap may be pulled outwardly with connector 32 then mating and releasably locking with its companion connector 40. Likewise, a seat belt buckle 35 (FIG. 6) or a seat belt tongue 36 (FIG. 7) may be fixedly mounted to the distal end of the strap and engage a companion connector provided on the back rest of the seat. In the case of utilization of buckle 35, shown in FIG. 6, a tongue 41 is fixedly mounted to the back rest 34 of the seat whereas in the case of the design shown in FIG. 7, a seat belt buckle 42 is mounted to the back rest 34 of the seat and releasably engages tongue 36. In FIG. 8, a connector restraint coupling 37 has a mouth and a lever within the mouth to lockingly and releasably engage an anchor 43 affixed to the vehicle or the back rest 34 of the seat. Several versions of the restraint coupling are disclosed in U.S. Pat. Nos. 6,962,394; 6,820,310 and 6,017,087 which are hereby incorporated by reference in their entirety. The connector shown in FIG. 44 of U.S. Pat. No. 6,962,394 is particularly useful in this application.

Variations in the retractor over that shown in the drawings are included in the present invention. For example, the various connectors shown in FIGS. 5-8 may use the compression spring or the extension spring version shown in FIGS. 1-4. Further, the tube 10 with spring therein may be mounted in the back rest in lieu of the seat portion with connectors reversed in each FIG. 5-8. For example, the anchor 43 of FIG. 8 may be mounted on the seat portion with the connector 37 mounted on the back rest.

The system disclosed herein includes a tube containing an extension or compression spring. One end of flexible webbing is connected to the spring. The other end of the flexible webbing contains half of a latch system. The other half of the latch system is attached to the back rest of a seat. When the web is pulled out, the spring is loaded creating resistance. When the latch on the web and on the back rest are connected, the resistance in the spring holds the seat back rest down. When the latch is released the loaded spring causes the web to retract.

While the invention has been illustrated and described in detail in the drawings and foregoing description, the same is to be considered as illustrative and not restrictive in character, it being understood that only the preferred embodiments have been shown and described and that all changes and modifications that come within the spirit of the invention are desired to be protected.

What is claimed is:

1. A foldable seat comprising:
a bottom portion upon which a person may sit;
a back portion against which a person may rest, said back portion movably mounted to said bottom portion and having an upright position whereat said back portion extends upwardly from said bottom portion and a downward position whereat said back portion is folded down atop said back portion;
a connector mounted to the seat;
a lockdown element movably mounted to the seat and extendable from a retracted position to an extended position to releasably connect to said connector whereat said element holds said bottom portion and said back portion together in said downward position; and,
a spring connected to said element, said spring having a normal state urging said element to said retracted position but yieldable to allow said element to extend out to said connector.

2. The seat of claim 1 and further comprising:
a tube having said spring positioned therein with said spring having a first end and a second end;
a first stop located in said tube and having said first end of said spring resting there against limiting movement of said first end as said spring yields with extension of said element; and,
a second stop located in said tube and having said second end of said spring resting there against allowing said spring to move to said normal state as said element is retracted.

3. The seat of claim 2 and further comprising:
a line extending through said first stop and said spring which is a compression spring with said line connected to said second stop; and wherein:
said tube has a closed end and an open end, said second stop is movably mounted in said tube and is movable in a direction from said closed end toward said open end as said spring compresses and said element extends from said tube, said second stop is movable in a direction from said open end toward said closed end as said spring assumes the normal state retracting said element in said tube.

4. The seat of claim 1 wherein:
said element is a strap with a mounted end connected to said spring and a free end; and further comprising:
a seat belt buckle connected to said free end of said element and said connector is a seat belt tongue with said buckle and said tongue releasably connectable together.

5. The seat of claim 1 wherein:
said element is a strap with a mounted end connected to said spring and a free end; and further comprising:
a latch connected to said free end of said element and said connector is an anchor with said latch and anchor releasably connectable together.

6. The seat of claim 1 wherein:
said element is a strap with a mounted end connected to said spring and a free end; and further comprising:
a first snap connector connected to said free end of said element and said connector is a second snap connector with first snap connector and said second snap connector releasably connectable together.

7. The seat of claim 1 wherein:
said element is a strap with a mounted end connected to said spring and a free end; and further comprising:
a tongue connected to said free end of said element and said connector is a seat belt buckle with buckle and tongue connector releasably connectable together.

8. The seat of claim 3 and further comprising a cap mounted to said open end and including a slot through which said element extends.

9. A seat comprising:
a first connector mounted to a seat;
a back rest;
a seat portion having said back rest pivotally mounted thereto and movable from an erect position to a storage position resting atop said seat portion;
a strap mounted within said seat and movable from a normal retracted position to an extended position, said strap has a distal end with a second connector mounted thereto that is releasably lockable with said first connector when said back rest is in said storage position to releasably hold said back rest atop said seat portion in said storage position; and,
a spring connected to said strap and said seat and normally urging said strap to withdraw into said seat but yieldable to allow said strap to extend outwardly therefrom.

10. The seat of claim 9 and further comprising:
a tube mounted within said seat portion having said spring and said strap positioned therein, said tube including an open end through which said strap is extendable therethrough to move from said normal retracted position to said extended position and back.

11. The seat of claim 10 and further comprising:
a first plate mounted in said tube;
a second plate spaced apart from said first plate and positioned in said tube with said spring extending between said first plate and said second plate.

12. The seat of claim 11 wherein:
said first plate is fixedly mounted to said tube whereas said second plate slides within said tube; and further comprising:
a line fixed to said second plate and extending slidably through said first plate and said spring and being attached to said strap.

13. The seat of claim 12 wherein:
said spring is a compression spring.

14. The seat of claim 11 wherein:
said spring is an extension spring.

15. The combination of:
a boat seat including a seat portion upon which a person may sit and a back rest against which the person may rest, said back rest is movably mounted to said seat portion and has an erect position extending upwardly from said seat portion and a storage position resting atop said seat portion; and,
an assembly mounted within said seat portion including a spring and a strap connected to said spring, said spring has a yielding state wherein said strap is extended outwardly from said seat and a normal state wherein at least a portion of said strap is withdrawn into said seat portion.

16. The combination of claim 15 wherein:
said spring is a compression spring.

17. The combination of claim 16 wherein:
said spring is an extension spring.

18. The combination of claim 16 wherein:
said assembly includes a tube housing said spring, said spring has a first end fixed relative to said tube so as to limit relative motion therebetween, said spring has a second opposite end connected to said strap, said strap is pullable outwardly from said tube moving said second end relative to said tube and moving said spring into said yielding state whereat said spring urges said strap to return toward said tube.

19. The combination of claim 16 wherein:
said tube is mounted in said seat portion, said back rest includes a first connector mounted thereto, said strap has a distal end with a second connector mounted thereto matable with said first connector, said spring urging said strap to return toward said tube when in said yielding state and said first connector is connected to said second connector holding said back rest atop said seat portion in said storage position.
